(19) United States
(12) Patent Application Publication
(10) Pub. No.: US 2026/0225557 A1
(43) Pub. Date: Aug. 6, 2026

(54) VEHICLE CONTROL DEVICE

(71) Applicant: TOYOTA JIDOSHA KABUSHIKI KAISHA, Toyota-shi (JP)

(72) Inventors: Yuta TAKATA, Toyota-Shi (JP); Hiroki TAKEISHI, Machida-shi (JP); Ryota TATSUMI, Nagoya-shi (JP); Mizuki MAJIMA, Ichinomiya-shi (JP)

(73) Assignee: TOYOTA JIDOSHA KABUSHIKI KAISHA, Toyota-shi (JP)

(21) Appl. No.: 19/404,412

(22) Filed: Dec. 1, 2025

(30) Foreign Application Priority Data
Jan. 28, 2025 (JP) 2025-012444

(51) Int. Cl. B60R 25/04; B60H 1/00; B60R 25/24

(52) U.S. Cl. CPC B60R 25/04; B60H 1/00657; B60R 25/24

(57) ABSTRACT

A vehicle control device includes: a processor that remotely controls a vehicle to lock an engine start of the vehicle by outputting, to the vehicle, a signal for operating an immobilizer of the vehicle in a case where the vehicle satisfies a predetermined requirement for an engine start lock, and remotely controls, in a case of detecting an output of a remote operation request for in-vehicle equipment which request involves the engine start of the vehicle from a terminal of a user of the vehicle during the engine start lock, the vehicle to respond to the remote operation request while keeping the engine start of the vehicle locked by outputting, to the vehicle, a signal for permitting only remote operation of the in-vehicle equipment without the engine start.

### CROSS-REFERENCE TO RELATED APPLICATIONS

The present application claims priority to and incorporates by reference the entire contents of Japanese Patent Application No. 2025-012444 filed in Japan on January 28, 2025.

### BACKGROUND

The present disclosure relates to a vehicle control device.

Japanese Patent No. 6647509 discloses a technology of executing an engine start lock on the basis of position information of a vehicle in a case where a reservation condition of releasing the engine start lock of the vehicle is violated.

### SUMMARY

There is a need for providing a vehicle control device capable of controlling an unintended engine start in a case where remote operation is performed during an engine start lock of a vehicle.

A vehicle control device according to the present disclosure includes: a processor that remotely controls a vehicle to lock an engine start of the vehicle by outputting, to the vehicle, a signal for operating an immobilizer of the vehicle in a case where the vehicle satisfies a predetermined requirement for an engine start lock, and remotely controls, in a case of detecting an output of a remote operation request for in-vehicle equipment which request involves the engine start of the vehicle from a terminal of a user of the vehicle during the engine start lock, the vehicle to respond to the remote operation request while keeping the engine start of the vehicle locked by outputting, to the vehicle, a signal for permitting only remote operation of the in-vehicle equipment without the engine start.

A vehicle control device according to the present disclosure includes: a processor that remotely controls a vehicle to lock an engine start of the vehicle in a case where the vehicle satisfies a predetermined requirement for an engine start lock, and remotely controls, in a case of detecting transmission of a remote operation request for in-vehicle equipment which request involves an engine start of the vehicle from a terminal of a user of the vehicle during the engine start lock, the vehicle to respond to the remote operation request while keeping the engine start of the vehicle locked.

### BRIEF DESCRIPTION OF THE DRAWINGS

FIG. 1 is a block diagram illustrating a schematic configuration of a vehicle control system including a vehicle control device according to an embodiment; and

FIG. 2 is a flowchart illustrating an example of a flow of processing in a claim collection server that functions as the vehicle control device according to the embodiment.

### DETAILED DESCRIPTION

In the related art, for example, a remote operation service to remotely operate in-vehicle equipment (such as air conditioning equipment or the like) of a vehicle without getting on the vehicle is known. In such remote operation, there is operation that involves an engine start in order to control a decrease in remaining capacity of a battery that supplies power to the in-vehicle equipment, such as remote air conditioning. Thus, in a case where such remote operation is performed during the engine start lock, the engine may start even during the engine start lock.

A vehicle control device according to an embodiment of the present disclosure will be described with reference to the drawings. Note that components in the following embodiment include what can be easily replaced by those skilled in the art or what is substantially the same.

### Vehicle control system

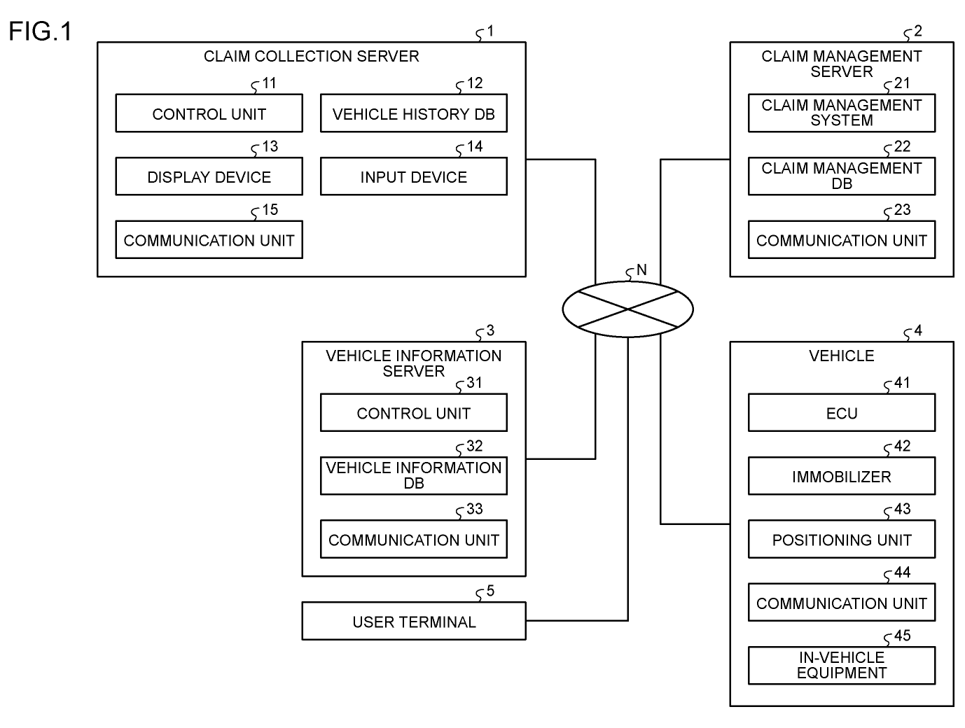

A vehicle control system according to the embodiment will be described with reference to FIG. 1. As illustrated in FIG. 1, the vehicle control system includes a claim collection server 1, a claim management server 2, a vehicle information server 3, a vehicle 4, and a user terminal 5. In the vehicle control system according to the embodiment, the claim collection server 1 functions as a vehicle control device that controls an operation (such as an engine start lock) of the vehicle 4.

The claim collection server 1, the claim management server 2, the vehicle information server 3, the vehicle 4, and the user terminal 5 all have a communication function, and are configured to be able to communicate with each other through a network N and exchange various kinds of information. This network N includes a public line network such as an Internet network, a mobile phone network, or the like.

### Claim collection server

The claim collection server 1 remotely controls the vehicle 4 to collect a claim related to the vehicle 4. Examples of the "claim" of the present embodiment include a claim related to an installment contract at the time of vehicle purchase, a claim related to a lease contract of the vehicle 4, a claim related to a subscription contract of the vehicle 4, a claim related to a car rental contract of the vehicle 4, and a claim related to a car sharing contract of the vehicle 4.

In addition, a creditor in the present embodiment is, for example, a holder (owner) of the vehicle 4. Specific examples of the creditor include a dealer of the vehicle 4, a credit company, and a car sharing company. In addition, a debtor in the present embodiment is, for example, a user of the vehicle 4. Specific examples of the debtor include a purchaser of the vehicle 4, a contractor of the lease contract, the car rental contract, and the car sharing contract.

As illustrated in FIG. 1, the claim collection server 1 includes a control unit 11, a vehicle history DB 12, a display device 13, an input device 14, and a communication unit 15.

The control unit 11 is realized by, for example, a processor including a central processing unit (CPU) and the like, and a memory (main storage unit) including a random access memory (RAM), a read only memory (ROM), and the like.

In a case where the vehicle 4 satisfies a predetermined requirement for an engine start lock (hereinafter, referred to as "engine start lock requirement"), the control unit 11 remotely controls the vehicle 4 in such a manner that the engine start of the vehicle 4 is locked. In this case, the control unit 11 outputs a signal for operating an immobilizer 42 to the vehicle 4 through the network N, and operates the immobilizer 42. As a result, the control unit 11 remotely locks the engine start of the vehicle 4. Specifically, the signal for operating the immobilizer 42 is transmitted from the control unit 11 to the vehicle information server 3, and is transmitted to the vehicle 4 via the vehicle information server 3.

The "case where the engine start lock requirement is satisfied" includes, for example, a case where the user of the vehicle 4 is in default. Examples of the "default" include a payment delay of a loan, a lease fee, a rental car fee, a sharing fee, or the like of the vehicle 4, a return delay of the vehicle 4 after use, and the like.

For example, the claim management server 2 determines whether the engine start lock requirement is satisfied. That is, in a case where the claim management server 2 determines that there is a vehicle 4 that satisfies the engine start lock requirement, information to specify the vehicle 4 is transmitted from a claim management system 21 to the claim collection server 1. The information to specify the vehicle 4 includes, for example, a vehicle identification number (VIN number), information related to a position of the vehicle 4 (hereinafter, referred to as “vehicle position information"), and the like.

Then, in a case of acquiring the information related to the vehicle 4 that satisfies the engine start lock requirement from the claim management system 21, the control unit 11 remotely controls, via the vehicle information server 3 as described above, the vehicle 4 in such a manner that the engine start of the vehicle 4 is locked.

In addition, in a case of receiving an application for a release of the engine start lock from the user of the vehicle 4 after the engine start lock of the vehicle 4, the control unit 11 remotely controls the vehicle 4 in such a manner that the engine start lock is released only for a predetermined period. In this case, for example, in a case of acquiring release application information of the engine start lock from a terminal (lock release application device) or the like connected to the claim collection server 1 through the network N, the control unit 11 outputs a signal for releasing the operation of the immobilizer 42 to the vehicle 4 through the network N, and releases the operation of the immobilizer 42. As a result, the control unit 11 remotely releases the engine start lock of the vehicle 4. Note that the signal for releasing the operation of the immobilizer 42 is transmitted from the control unit 11 to the vehicle information server 3, and is transmitted to the vehicle 4 via the vehicle information server 3.

In addition, the control unit 11 remotely controls the vehicle 4 in such a manner as to lock the engine start again after a lapse of a predetermined period from the release of the engine start lock in the above manner.

Furthermore, in a case of detecting that a remote operation request for in-vehicle equipment 45 which request involves the engine start of the vehicle 4 is transmitted from the user terminal 5 owned by the user of the vehicle 4 during the engine start lock, the control unit 11 remotely controls the vehicle 4 in such a manner as to respond to the remote operation request while keeping the engine start of the vehicle 4 locked.

In this case, in a case of acquiring information related to the remote operation request for the vehicle 4 from the user terminal 5 (hereinafter, referred to as "remote operation request information"), for example, from the vehicle information server 3, the control unit 11 detects that the remote operation request for the in-vehicle equipment 45 which request involves the engine start is transmitted. The "remote operation request information" includes, for example, information for specifying the vehicle 4 (such as a vehicle identification number (VIN number) or the like), a type of the in-vehicle equipment 45 for which the remote operation request is made, presence/absence of the engine start at the time of the remote operation, and the like.

Then, in a case of detecting that the remote operation request for the in-vehicle equipment 45 which request involves the engine start is transmitted, the control unit 11 transmits, to the vehicle 4, a signal for permitting only the remote operation of the in-vehicle equipment 45 without the engine start. As a result, the vehicle 4 is remotely controlled to respond to the remote operation request from the user terminal 5 while the engine start of the vehicle 4 is locked. Hereinafter, the remaining configuration of the claim collection server 1 will be described.

The vehicle history DB 12 is a database that accumulates various kinds of information related to the vehicle 4. For example, the following information is accumulated in the vehicle history DB 12.

(1) Vehicle identification number (VIN number) of the vehicle 4

(2) Vehicle position information of the vehicle 4

(3) Release application information acquired from a lock release application device

The display device 13 is realized by, for example, a liquid crystal display (LCD), an organic EL display (OLED), or the like, and displays various kinds of information created by the control unit 11. Furthermore, the input device 14 is realized by, for example, a keyboard, a pointing device, or the like, and inputs various kinds of information to the control unit 11.

The communication unit 15 includes, for example, a local area network (LAN) interface board, a wireless communication circuit for wireless communication, and the like. The communication unit 15 exchanges information with the claim management server 2 and the vehicle information server 3 by the communication through the network N.

### Claim management server

The claim management server 2 is to manage a claim related to the vehicle 4. As illustrated in FIG. 1, the claim management server 2 includes the claim management system 21, a claim management DB 22, and a communication unit 23.

In a case where there is a vehicle 4 that satisfies the engine start lock requirement among vehicles 4 managed by the claim management DB 22, the claim management system 21 transmits information for specifying the vehicle 4 (such as a vehicle identification number (VIN number) or the like) to the claim collection server 1.

The claim management DB 22 is a database that accumulates, for example, information for specifying the vehicle 4 (such as the vehicle identification number (VIN number) or the like), information related to a claim of the vehicle 4 (such as a loan claim, a lease claim, and the like), and the like.

The communication unit 23 includes, for example, a LAN interface board, a wireless communication circuit for wireless communication, and the like. The communication unit 23 exchanges information with the claim collection server 1 by the communication through the network N.

### Vehicle information server

The vehicle information server 3 includes a control unit 31, a vehicle information DB 32, and a communication unit 33.

The control unit 31 is realized by, for example, a processor including a CPU and the like, and a memory (main storage unit) including a RAM, a ROM, and the like. In a case of acquiring the signal for operating the immobilizer 42 of the vehicle 4 from the claim collection server 1, the control unit 31 remotely locks the engine start of the vehicle 4 by transferring the signal to the vehicle 4. In addition, in a case of acquiring the signal for releasing the operation of the immobilizer 42 of the vehicle 4 from the claim collection server 1, the control unit 31 remotely releases the engine start lock of the vehicle 4 by transferring the signal to the vehicle 4.

In a case of acquiring the remote operation request information for the in-vehicle equipment 45 of the vehicle 4 from the user terminal 5, the control unit 31 transfers the remote operation request information to the claim collection server 1. In addition, in a case of acquiring, from the claim collection server 1, the signal for permitting only the remote operation of the in-vehicle equipment 45 without the engine start, the control unit 31 transfers the signal to the vehicle 4.

The vehicle information DB 32 is a database that accumulates various kinds of information acquired from the vehicle 4. For example, the following information is accumulated in the vehicle information DB 32. In addition, the vehicle information DB 32 transmits the following information to the claim collection server 1 in accordance with a request from the claim collection server 1.

(1) Vehicle identification number (VIN number) of the vehicle 4

(2) Vehicle position information of the vehicle 4

The communication unit 33 includes, for example, a LAN interface board, a wireless communication circuit for wireless communication, and the like. The communication unit 33 exchanges information with the claim collection

server 1, the vehicle 4, and the user terminal 5 by the communication through the network N.

### Vehicle

The vehicle 4 is, for example, a general engine vehicle (related-art vehicle), a hybrid electric vehicle (HEV), a plug-in hybrid electric vehicle (PHEV), or the like. In addition, the vehicle 4 may be, for example, a fuel cell electric vehicle (FCEV), a battery electric vehicle (BEV), or the like. The vehicle 4 includes an ECU 41, the immobilizer 42, a positioning unit 43, a communication unit 44, and the in-vehicle equipment 45.

The ECU 41 is an electronic control unit including, as a main component, a microcomputer including a CPU, a ROM, a RAM, and the like, for example. The ECU 41 transmits information including at least the vehicle position information to the vehicle information server 3 in accordance with a request from the vehicle information server 3.

In a case of acquiring the signal for operating the immobilizer 42 of the vehicle 4 from the vehicle information server 3, the ECU 41 controls the immobilizer 42 and locks the engine start of the vehicle 4. In a case of acquiring the signal for releasing the operation of the immobilizer 42 of the vehicle 4 from the vehicle information server 3, the ECU 41 controls the immobilizer 42 and releases the engine start lock of the vehicle 4.

In a case of acquiring, from the vehicle information server 3, the signal for permitting only the remote operation of the in-vehicle equipment 45 without the engine start, the ECU 41 operates the in-vehicle equipment 45 without the engine start. For example, in a case where the in-vehicle equipment 45 is air conditioning equipment, the ECU 41 operates the air conditioning equipment in a state in which the engine start is restricted (prohibited).

For example, the user terminal 5 makes the remote operation request to the vehicle 4 via the vehicle information server 3. That is, the user terminal 5 generates the remote operation request information on the basis of information input by the user through an input means (such as a keyboard or touch panel) or the like, and transmits the generated remote operation request information to the vehicle information server 3. In response to this, the vehicle information server 3 transfers the remote operation request information to the claim collection server 1. In response to this, the claim collection server 1 generates the signal for permitting only the remote operation of the in-vehicle equipment 45 without the engine start.

Subsequently, the signal for permitting only the remote operation of the in-vehicle equipment 45 without the engine start is transmitted from the claim collection server 1 to the vehicle information server 3. Subsequently, the signal for permitting only the remote operation of the in-vehicle equipment 45 without the engine start is transferred from the vehicle information server 3 to the vehicle 4, whereby the remote operation of the in-vehicle equipment 45 in a state in which the engine start is locked is performed.

The immobilizer 42 activates the engine start lock or releases the activation of the engine start lock on the basis of the control by the ECU 41.

For example, the positioning unit 43 receives radio waves from global positioning system (GPS) satellites and detects a current position of the vehicle 4. Specifically, on the basis of time when the radio waves are transmitted from the plurality of GPS satellites and time when the positioning unit 43 receives the radio waves, the positioning unit 43 calculates a distance between each of the GPS satellites and the vehicle 4, and calculates the current position of the vehicle 4 on the basis of the distances. Note that a method of detecting the current position of the vehicle 4 by the positioning unit 43 is not limited to the method using the GPS satellites, and the current position of the vehicle 4 may be detected by combination of Light Detection and Ranging or Laser Imaging Detection and Ranging (LiDAR) and a 3D map, for example.

The communication unit 44 includes, for example, a data communication module (DCM) or the like. The communication unit 44 exchanges information with the vehicle information server 3 by the communication through the network N.

The in-vehicle equipment 45 is equipment mounted on the vehicle 4, and is equipment that can be remotely operated by the user terminal 5. In addition, the in-vehicle equipment 45 specifically indicates equipment that involves the engine start when being used in the remote operation among pieces of equipment mounted on the vehicle 4. Examples of the in-vehicle equipment 45 include the air conditioning equipment (air conditioner) and the like. Note that the in-vehicle equipment 45 may be equipment other than the air conditioning equipment as long as being the equipment that involves the engine start at the time of being used in the remote operation.

### User terminal 5

The user terminal 5 is to perform the remote operation of the in-vehicle equipment 45 of the vehicle 4. Examples of the user terminal 5 include an information processing terminal (such as a personal computer or smartphone) owned by the user of the vehicle 4.

For example, the user terminal 5 makes the remote operation request to the vehicle 4 via the vehicle information server 3. That is, the user terminal 5 generates the remote operation request information on the basis of the information input by the user through the input means (such as the keyboard or touch panel) or the like, and transmits the generated remote operation request information to the vehicle information server 3. In response to this, the vehicle information server 3 transfers the remote operation request information to the claim collection server 1. In response to this, the claim collection server 1 generates the signal for permitting only the remote operation of the in-vehicle equipment 45 without the engine start.

Subsequently, the signal for permitting only the remote operation of the in-vehicle equipment 45 without the engine start is transmitted from the claim collection server 1 to the vehicle information server 3. Subsequently, the signal for permitting only the remote operation of the in-vehicle equipment 45 without the engine start is transferred from the vehicle information server 3 to the vehicle 4, whereby the remote operation of the in-vehicle equipment 45 in a state in which the engine start is locked is performed.

### Processing in the claim collection server

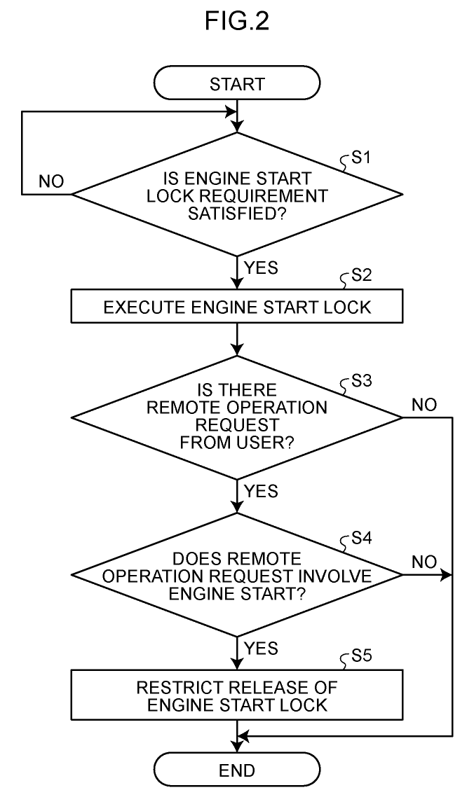

An example of a flow of processing in the claim collection server 1 will be described with reference to FIG. 2.

First, the control unit 11 determines whether the vehicle 4 satisfies a requirement for the engine start lock (Step S1). In Step S1, the control unit 11 determines that the requirement for the engine start lock is satisfied in a case where information for specifying the vehicle 4 satisfying the engine start lock requirement is acquired from the claim management server 2, for example.

In a case where it is determined in Step S1 that the vehicle 4 satisfies the requirement for the engine start lock (Yes in Step S1), the control unit 11 remotely operates the vehicle 4 and executes the engine start lock (Step S2). In Step S2, the control unit 11 executes the engine start lock, for example, by transmitting the signal for operating the immobilizer 42 to the vehicle 4 via the vehicle information server 3.

Subsequently, the control unit 11 determines whether there is the remote operation request from the user (Step S3). In Step S3, in a case of acquiring the remote operation request information, for example, from the vehicle information server 3, the control unit 11 determines that there is the remote operation request from the user.

In a case of determining in Step S3 that there is the remote operation request from the user (Yes in Step S3), the control unit 11 determines whether the remote operation request is the remote operation request that involves the engine start (Step S4). In Step S4, the control unit 11 determines whether the remote operation request involves the engine start by checking, for example, information that is related to a type of the in-vehicle equipment 45 and presence/absence of the engine start at the time of the remote operation and that is included in the remote operation request information.

In a case where it is determined in Step S4 that the remote operation request involves the engine start (Yes in Step S4), the control unit 11 restricts (prohibits) the release of the engine start of the vehicle 4 (Step S5), and remotely controls the vehicle 4 to respond to the remote operation request while keeping the engine start locked.

Here, in a case of determining in Step S1 that the vehicle 4 does not satisfy the requirement for the engine start lock (No in Step S1), the control unit 11 returns to the determination in Step S1. In addition, in a case of determining in Step S3 that there is no remote operation request from the user (No in Step S3), the control unit 11 completes the present processing. In a case of determining in Step S4 that the remote operation request does not involve the engine start (No in Step S4), the control unit 11 completes the present processing.

In the vehicle control device according to the embodiment described above, in a case where the user (user terminal 5) makes the remote operation request for the in-vehicle equipment 45 which request involves the engine start of the vehicle 4, the vehicle 4 is remotely controlled to respond to the remote operation request from the user while the engine start of the vehicle 4 is locked. Thus, according to the vehicle control device of the embodiment, it is possible to suppress an unintended engine start in a case where the remote operation is performed during the engine start lock of the vehicle 4.

Further effects and modification examples can be easily derived by those skilled in the art. Thus, broader aspects of the present disclosure are not limited by the specific details and representative embodiments that are illustrated and described in the above manner. Thus, various modifications can be made without departing from the spirit or scope of a general concept of the disclosure defined by the accompanying claims and an equivalent thereof.

For example, although the description has been made on the assumption that the claim collection server 1 functions as the vehicle control device in the present embodiment, the vehicle 4 itself may function as the vehicle control device. In this case, the vehicle 4 may have the functions of the control unit 11 and the vehicle history DB 12 of the claim collection server 1. Furthermore, in the vehicle control device according to the embodiment, the vehicle 4 may perform a part of the processing of the claim collection server 1 or the vehicle information server 3.

For example, all of (1) and (2) in the following may be performed by the claim collection server 1 or may be performed by the vehicle 4. In addition, (1) in the following may be performed by the vehicle 4, and (2) in the following may be performed by the claim collection server 1. Furthermore, (2) in the following may be performed by the vehicle 4, and (1) in the following may be performed by the claim collection server 1.

### 1. Engine start lock

### 2. Release of the engine start lock

In addition, although the claim collection server 1, the claim management server 2, and the vehicle information server 3 have been described as separate devices in the present embodiment, the claim collection server 1, the claim management server 2, and the vehicle information server 3 may be formed of one device, two devices, or four or more devices.

According to the present disclosure, it is possible to control an unintended engine start in a case where remote operation is performed during an engine start lock of a vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle control device comprising:
a processor that
remotely controls a vehicle to lock an engine start of the vehicle by outputting, to the vehicle, a signal for operating an immobilizer of the vehicle in a case where the vehicle satisfies a predetermined requirement for an engine start lock, and
remotely controls, in a case of detecting an output of a remote operation request for in-vehicle equipment which request involves the engine start of the vehicle from a terminal of a user of the vehicle during the engine start lock, the vehicle to respond to the remote operation request while keeping the engine start of the vehicle locked by outputting, to the vehicle, a signal for permitting only remote operation of the in-vehicle equipment without the engine start.

2. The vehicle control device according to claim 1, wherein the in-vehicle equipment is air conditioning equipment.

3. A vehicle control device comprising:
a processor that
remotely controls a vehicle to lock an engine start of the vehicle in a case where the vehicle satisfies a predetermined requirement for an engine start lock, and
remotely controls, in a case of detecting transmission of a remote operation request for in-vehicle equipment which request involves an engine start of the vehicle from a terminal of a user of the vehicle during the engine start lock, the vehicle to respond to the remote operation request while keeping the engine start of the vehicle locked.

4. The vehicle control device according to claim 3, wherein the in-vehicle equipment is air conditioning equipment.
